(19) United States
(12) Patent Application Publication
(10) Pub. No.: US 2004/0262132 A1
(43) Pub. Date: Dec. 30, 2004

(54) Method and system for conveyor belt monitoring

(76) Inventors: Timothy Joseph Pauley, Tasmania (AU); Robert Neil Mackinlay, Roleystone (AU)

Correspondence Address: BANNER & WITCOFF, 1001 G STREET N W, SUITE 1100, WASHINGTON, DC, 20001, US

(21) Appl. No.: 10/494,306

(22) PCT Filed: Nov. 1, 2002
(86) PCT No.: PCT/AU02/01477

(30) Foreign Application Priority Data
Nov. 2, 2001 (AU) PR 8664

(51) Int. Cl. B65G 43/00

(52) U.S. Cl. 198/810.02

(57) ABSTRACT

This invention relates to a conveyor monitoring system for monitoring the integrity of a conveyor belt during operation as to detect when a safe level of wear or tear has been breached. The system including a detection member (13) being electrically conductive when intact and electrically non-conductive when broken, and a transmitter (15) transmitting the conductivity condition of the detection member. The monitoring system preferably also includes a scanner (20) which communicates with the transmitter (15) to receive data regarding the conductivity condition of the detector member (13). The scanner (20) preferably communicates with the monitoring station (130) which provides a visual indication of the conductivity condition of the detector member (13), and provides a visual and/or audible signal when the safe level of wear or tear for the conveyor belt has been breached.

### CROSS REFERENCE TO RELATED APPLICATIONS

This is a U.S. National Phase Application under 35 U.S.C. § 371 of International Application No. PCT/AU02/01477 filed Nov. 1, 2002, which was published Under PCT Article 21(2), which claims priority to Australian Application No. PR8664, filed Nov. 2, 2001, the entire contents of which are incorporated herein by reference.

### FIELD OF THE INVENTION

The present invention relates to a system including conveyor belt wear indicators for monitoring a conveyor belt, a conveyor belt including the system and a method of installing the system. More specifically the system monitors the integrity of the conveyor belt and it will be convenient to hereinafter describe the invention with reference to this application. However, it should be appreciated that the invention has wider application including indexing and predicting performance of a conveyor belt.

### DESCRIPTION OF THE PRIOR ART

Conveyor belts are widely used in many applications, varying from relatively short belts which function to move loads between plant processes and/or storage, through to long overland belt systems which function to transport loads such as ore tens of kilometers, such as are common in the mining industry. Therefore, a conveyor belt can represent a large investment.

Conveyor belts typically comprise a lower structural layer having load bearing longitudinal armoring of multi-stranded steel cables, a single wide steel strap or other reinforcing material. An upper layer or load bearing layer is slowly worn away in use. Belt sections are often provided with a wear guarantee specifying the safe total load that the belt can safely transport during its life before the integrity of the belt section is likely to be compromised.

Over time, the load bearing surface of a conveyor belt is worn down by the materials carried by the belt. Tears or faults may occur in the belt as a result of such gradual wear, or may occur as a result of a sudden shock-loading caused by heavy materials dropped in a rough manner onto the belt. Tears or faults which breach a safe level can affect the integrity of the belt and its ability to function safely.

When a tear or fault occurs, it will usually be aligned generally along the direction of travel of the belt, as conveyor belts typically include reinforcing elements such as embedded steel cables along the belt, which tend to prevent tears from forming across the belt. Undetected a tear can further propagate and even result in an inner section of a belt dropping, getting caught in fixed structures and resulting in a long section of belt being destroyed. Such instances result in destruction of sections of belt and down time for the installation as a whole while a new section is spliced in. Naturally it is preferred that the conveyor belt be repaired when it breaches a safe level of wear or tear.

An existing method of detecting the occurrence of such tears involves placing a trip-wire or the like a small distance below the normal operating position of the conveyor belt. When a sufficiently large tear occurs, the conveyor belt around the periphery of the tear will tend to droop lower than normal, thereby contacting or breaking the wire which causes an indication to be made that a tear or fault has been detected. However, this method will only detect faults which cause the conveyor belt to droop lower than the normal operating position. Therefore smaller tears, faults or tears that extend along the axis of the belt are generally not detected by this method, and continued operation of the conveyor belt will exacerbate the fault, leading to higher repair costs if and when the fault is eventually detected. Further, even when a fault is detected, shut-down of a conveyor belt is usually a somewhat time-consuming process, and so the fault may be situated an unknown distance from the fault detector once the belt finally comes to a halt, necessitating a laborious visual inspection of the belt in order to locate the fault for repair.

Accordingly, it is known to use transmitters, such as radio frequency transponders, in association with a conveyor belt in order to identify the location of faults and to mark and track specific points of interest along the conveyor belt. However, in the systems known in the prior art, transponders used for monitoring the integrity of a conveyor belt operate by providing a negative indication of a fault. For example, in Australian Patent No. 718148, issued to ContiTech Transportbandsystemes GmbH, there is disclosed a system in which transponders embedded within a conveyor belt are either damaged or fall out when a specified level of wear is reached, resulting in a loss of signal. Such systems suffer from the problem that a loss of signal may also be due to a failure of the transponder, resulting in false alarms that may cause costly downtime in the operation of the conveyor belt. In Australian Patent No. 718148, this problem is addressed by installing the transponders in a manner intended to minimize the occurrence of transponder failure due to normal operation of the conveyor belt, however it is clear that such a solution cannot completely eliminate false alarms.

Furthermore, most of the methods disclosed in the prior art for installing monitoring devices in conveyor belts relate to inserting transponders and failure detectors during manufacture or repair of the belt, for example by embedding the devices between layers of the belt structure. Accordingly, there is a need for simple and cost effective methods for effectively retrofitting monitoring systems to conveyor belts that were not manufactured with such systems installed.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

According to a first aspect of the invention there is provided a conveyor belt monitoring system indicating a level of wear or tear of a conveyor belt, including:

a first detection member residing within the conveyor belt at a predetermined depth below a load carrying surface of the belt, the first detection member electrically conductive when intact and electrically non-conductive when breached, and arranged such that the first detection member is breached when the level of wear or tear of the belt reaches or exceeds said predetermined depth; and

a first transmitter electrically connected to the first detection member, the first transmitter, in use, only transmitting a signal when the first detection member is electrically non-conductive.

The invention therefore provides the advantage over prior art systems that the transmitter generates a positive indication of wear or tear of the conveyor belt by transmitting a signal when the level of wear or tear of the belt reaches or exceeds the depth determined by the placement member. Accordingly, false alarms due to transmitter failure are avoided, and the signal generated by the transmitter enables the location of the worn or damaged section of the conveyor belt to be easily located without the need for laborious visual inspection.

Preferably the monitoring system further includes:

a second detection member residing within the conveyor belt in close proximity to the first detection member at substantially the same predetermined depth below the load carrying surface of the belt, the second detection member electrically conductive when intact and electrically non-conductive when breached, and arranged such that the second detection member is breached when the level of wear of tear of the belt reaches or exceeds said predetermined depth; and

a second transmitter electrically connected to the second detection member, the second transmitter, in use, only transmitting a signal when the second detection member is electrically conductive.

Advantageously, this arrangement ensures that one of the first and second transmitters is transmitting at all times, with transmission by the second transmitter indicating that the conveyor belt is in good condition while transmission by the first transmitter indicates that the predetermined level of wear or tear has been reached or exceeded. Transmission by both or neither transmitter may be interpreted as a fault in the transmitters and/or detection members, and is readily distinguished from belt wear. The arrangement thus provides a form of “fail-safe” operation in which there is redundancy of transmitters in case of a failure, without simultaneous transmission that may lead to interference between the respective signals. Furthermore, the availability of transmissions at all times enables the location of the detection members to be continuously tracked.

The first and/or second detection member may include one or more conductors configured as a conductive loop and may extend substantially across the conveyor belt. It is preferred that the conductors be pleated or corrugated along their length such that portions of the conductors are disposed above a nominal plane extending through the conductive loop, said portions, in use, being subject to wear and consequent breach prior to any conductors residing within said nominal plane. Preferably the first and/or second transmitter includes a radio frequency transponder.

In a preferred embodiment, the conveyor belt monitoring system includes a scanner unit that generates a radio frequency interrogation signal, and wherein the transponder of the first transmitter is non-responsive to the interrogation signal when the first detection member is electrically conductive, and responsive to the interrogation signal when the first detection member is electrically non-conductive. Furthermore, the transponder of the second transmitter is preferably responsive to the interrogation signal generated by the scanner unit when the second detection member is electrically conductive, and non-responsive to the interrogation signal when the second detection member is electrically non-conductive.

The conveyor belt monitoring system may include a plurality of first and second detection members each electrically connected to respective transmitters, each transmitter including a radio frequency transponder operable to respond to said interrogation signal of said scanner unit with a signal including information that uniquely identifies the transponder. The system may include one or more additional indexing transponders affixed to the conveyor belt, each indexing transponder operable to respond to said interrogation signal of said scanner unit with a signal including information that uniquely identifies the transponder.

Preferably the scanner unit is operably connected to an antenna positioned adjacent the conveyor belt and a reader unit that receives the signal received by the antenna, the reader unit also including a processor for processing the signal and logging the processed signal as data. In a preferred embodiment, the system includes a monitoring station in communication with the reader unit by cable or radio frequency transmission, wherein the monitoring station presents the data as system status information relating to the level of wear of the conveyor belt. The monitoring station may provide a geographical location of the first and/or second detection member, and may produce a visible and/or audible signal when the first and/or second detection member is breached.

The monitoring station may control operation of the conveyor belt, and may stop operation of the conveyor belt when the first and/or second detection member is breached. Preferably the operation of the conveyor belt is controlled by a PLC system in communication with the reader unit, and the PLC system may stop operation of the conveyor belt when the first and/or second detection member is breached.

According to another aspect, the invention provides a conveyor belt wear indicator for use with a conveyor belt monitoring system to indicate a level of wear or tear of the conveyor belt, the wear indicator including:

a first detection member for embedment within the conveyor belt at a predetermined depth below a load carrying surface of the belt, the first detection member being electrically conductive when intact and electrically non-conductive when breached; and

a first transmitter electrically connected to the first detection member, the first transmitter, in use, only transmitting a signal when the first detection member is electrically non-conductive.

The wear indicator may further include:

a second detection member for embedment within the conveyor belt in close proximity to the first detection member at substantially the same predetermined depth below the load carrying surface of the belt, the second detection member being electrically conductive when intact and electrically non-conductive when breached; and

a second transmitter electrically connected to the second detection member, the second transmitter, in use, only transmitting a signal when the second detection member is electrically conductive.

According to a further aspect, the invention provides a conveyor belt having a major longitudinal axis, a structural component and a load bearing component overlaying the structural component, the conveyor belt further including:

a first detection member residing within the conveyor belt at a predetermined depth below the surface of the load bearing component, the first detection member being electrically conductive when intact and electrically non-conductive when breached; and

a first transmitter electrically connected to the first detection member, the first transmitter, in use, only transmitting a signal when the first detection member is electrically non-conductive;

wherein the first detection member is oriented transverse to the major longitudinal axis of the belt and extends substantially across the conveyor belt.

Preferably, the conveyor belt further includes:

a second detection member residing within the conveyor belt in close proximity to the first detection member with substantially the same orientation and at substantially the same predetermined depth below the load carrying surface of the belt, the second detection member being electrically conductive when intact and electrically non-conductive when breached; and

a second transmitter electrically connected to the second detection member, the second transmitter, in use, only transmitting a signal when the second detection member is electrically conductive.

It is preferred that the first detection member is oriented substantially perpendicular to the major axis of the conveyor belt. Alternatively, the first detection member may be oriented at an acute angle to the major axis of the conveyor belt.

In a preferred embodiment, the depth at which the first detection member resides below the surface of the load bearing component represents a level of wear of the belt for which an indication is required. The belt may include a plurality of detection members residing at different depths below the surface of the load bearing component of the belt. The plurality of detection members may be oriented at different angles relative to the major longitudinal axis of the conveyor belt.

It is preferred that the first and/or second transmitter is positioned adjacent one side edge of the conveyor belt. The detection member and transmitter may be entirely embedded within the load bearing component of the conveyor belt. Alternatively, the detection member may be associated with the structural component of the conveyor belt. For example, the detection member may be formed integrally with the structural component.

According to yet another aspect, the invention provides a method of installing a conveyor belt wear indicator by embedding the indicator in a conveyor belt, including the steps of:

forming a groove in a surface of the conveyor belt substantially across the conveyor belt; and

placing a first wear indicator, including a first detection member electrically connected to a first transmitter, in the groove such that the detection member extends substantially across the conveyor belt.

The method thus provides the advantage that it may be used to install wear indicators into an existing conveyor belt, without the requirement that the indicators be installed at the time of manufacture or during repairs to the belt. Accordingly, the method of the invention may be used to retrofit a monitoring system to existing conveyor belts.

The groove is preferably formed in a load carrying surface of the conveyor belt, and the method preferably further includes the step, after placing the wear indicator(s) in the groove, of filling the groove with a material. It is preferred that the material has a surface wear rate substantially identical to a wear rate of the load carrying surface of the conveyor belt.

According to another aspect, the invention provides a method of installing a conveyor belt indexing transponder into a conveyor belt including the steps of:

forming a hole in an edge of the conveyor belt;

locating within said hole an indexing transponder operable to respond to an interrogation signal generated by a scanner unit, said response including information that uniquely identifies the transponder; and

sealing the hole.

It is preferred that the step of forming a hole includes drilling a hole in the side edge of the belt of diameter suitable to receive the indexing transponder, and the step of locating the indexing transponder within the hole includes the steps of:

providing an insertion tool having a barrel with an opening at the handle end;

inserting the barrel of the insertion tool into the hole;

placing the indexing transponder into the opening of the insertion tool; and

using a push rod to push the indexing transponder into the hole.

The step of sealing the hole may include placing a rubber plug into the opening of the insertion tool and subsequently operating the push rod to force the rubber plug into the hole. Additionally, an adhesive may be applied to the plug. The indexing transponder may be encased in a protective enclosure. It is preferred that the protective enclosure includes one or more of a fiberglass tube, a polycarbonate tube, or an epoxy or polyester resin encapsulation.

In still another aspect, the invention provides an indexing transponder for installation into a conveyor belt, the indexing transponder operable to respond to an interrogation signal generated by a scanner unit, said response including information that uniquely identifies the transponder, said radio frequency transponder being encased in a protective closure for placement in an insertion tool having a barrel and an opening at the handle end of the tool, whereafter the indexing transponder and protective closure are inserted into a hole formed in the conveyor belt using a push rod of the tool to force the indexing transponder into the hole through the barrel of the tool.

### BRIEF DESCRIPTION OF THE DRAWINGS

Examples of the invention will now be described with reference to the accompanying drawings in which:

FIGS. 1a-c depict a conveyor belt fault detection arrangement in accordance with an illustrative implementation of the present invention;

FIG. 2 illustrates a system for monitoring a plurality of conveyor belts in accordance with an illustrative implementation of the present invention; and

FIG. 3 is a circuit schematic of a scanning device for detecting conveyor belt inserts according to an illustrative implementation of the present invention.

### DETAILED DESCRIPTION

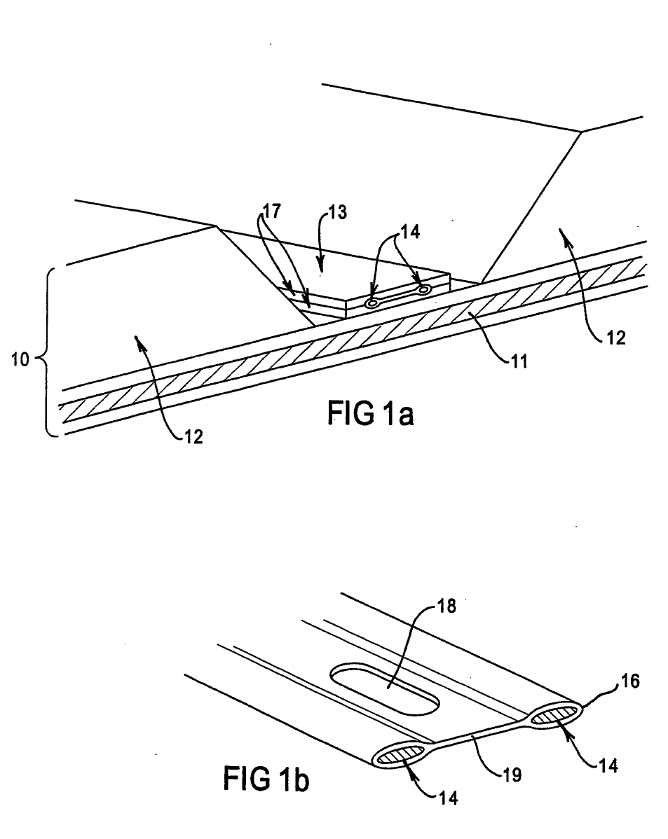

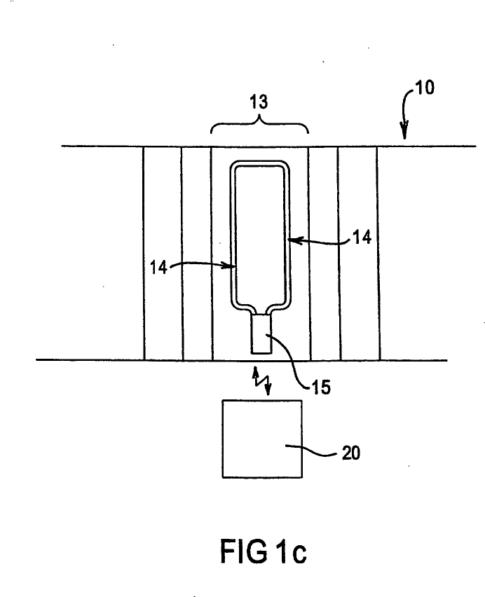

FIG. 1a depicts a conveyor belt fault detection arrangement in accordance with an illustrative implementation of the present invention. A partial cross-section of conveyor belt 10 shows structural cables 11 and a load bearing portion 12. A lateral groove has been formed in load bearing portion 12 and the conveyor belt fault detection arrangement 13, has been placed in the groove. As conveyor belts are often held with raised edges so as to cradle material placed on the belt, the belt is preferably jacked up on a horizontal bed in order to flatten the belt to assist in forming the lateral groove. In particular, a flat bed and hydraulic jacks maybe inserted between the belt and the load bearing structure on which the rollers and belt are supported. The flat bed may then be raised with the hydraulic jacks lifting and flattening a section of the belt in readiness for the grooving operation.

The conveyor belt fault detection arrangement 13 includes a detection member which in the preferred embodiment illustration is a detection loop extending substantially across the conveyor belt 10, the detection loop comprising conductors 14 which meet near a lateral extremity of the conveyor belt 10 so as to form a conductive return loop. Clearly other forms of detection members are possible.

The detection loop illustrated is encapsulated in a suitable rubber compound 17, for embedding in the rubber material 12 of the conveyor belt 10.

As an example, and as illustrated in FIG. 1b, the detection loop may be a two conductor cable being of relatively flat profile. Each conductor 14 is formed of single copper filaments which have been flattened and encapsulated in insulating material 16 (such as high strength polyester). The two conductors 14 are separated from each other by approximately 3.5 mm in this example. Alternatively, the detection loop may comprise a two conductor cable of flat profile, in which the conductors 14 are formed of single high-strength copper alloy filaments which have been flattened and encapsulated in insulating material 16 (such as high strength polyester), and are separated from each other by approximately 3.5 mm.

In both such configurations of the detection loop the conductors 14 may be pleated or corrugated along their length to provide high elongation capability in the event of localized tensile shock loads. In addition or alternatively, the detection loop may be positioned obliquely across the belt. By increasing the length of the loop, the degree of localized elongation of the loop materials when subject to localized shock or elongation during normal operation of a belt, may be reduced. In addition, pleated or corrugated conductors have localized points corresponding to the peaks of the pleats or corrugations that are raised above the nominal plane of the detection loop. Accordingly, under conditions of wear of the conveyor belt, the localized raised points of the conductor will be breached first, resulting in the wear condition being detected prior to more extensive damage being caused to the remainder of the detection loop or any connected transponder 15 (see FIG. 1c). Advantageously, the possibility is thus reduced that the detection arrangement will be destroyed under conditions of wear. The inclusion of pleats or corrugations may therefore result in improved reliability of the monitoring system.

Further, perforations 18 may be formed along the web 19 joining the conductors, to provide a key for the encapsulating material 17, which is to allow secure adhesion of the encapsulating material 17 about the conductors 14 and insulating material 16. Such perforations may also assist in allowing the conductors 14 to break when a fault occurs in the conveyor belt 10.

As a further alternative, the detection loop may comprise a two conductor cable being of relatively flat profile, the conductors 14 being formed of single high end count copper braids, which have been flattened and encapsulated in insulating material 16 suitable for embedding in the conveyor belt rubber 12.

The braid may be formed so that there is very high elongation before the individual strands are placed under high tensile loads to reduce the risk of breakage under localized tensile shock loads. The conductors are spaced from each other at such a distance as to reduce the likelihood of the individual strands 14 contacting each other when a break occurs in the detection loop.

Returning to FIG. 1a, it is noted that in order to complete installation of the conveyor belt fault detection means 13, the groove should be filled so as to embed the fault detection means within the conveyor belt 10. The groove should preferably be filled with a material having substantially the same wear characteristics as the load bearing portion 12.

FIG. 1c shows the conveyor belt 10 in plan view, and further illustrates a transmitter which in the preferred embodiment is a transponder 15 of the conveyor belt fault detection arrangement 13. The transponder 15 is electrically connected to the detection loop, which extends substantially entirely across the conveyor belt. It will be appreciated that the transponder and the detection loop are illustrated out of scale for clarity purposes, and in typical conveyor belts the detection loop will be significantly narrower and the transponder will be significantly smaller relative to the size of the belt than is shown. The transponder 15 is preferably located proximal to the lateral edge of the belt 10 to avoid damage to the transponder 15 which may be caused, for example, by the loading of materials occurring in the central region of the belt 10.

The transponder 15 communicates by RF transmissions with a scanner unit 20 positioned adjacent to the belt 10. The scanner unit 20 may be fixed, for example at points of interest such as loading points, or may be a hand held scanner unit. As the conveyor belt 10 moves and the conveyor belt fault detection means 13 passes the scanner unit 20, the scanner unit interrogates the transponder 15 by generating an electromagnetic field. The transponder may be self-powered, for example by a battery, or alternatively may obtain power received from the electromagnetic field generated by the scanner unit 20.

Upon receiving such an interrogation, the transponder 15 attempts to transmit a response to the scanner unit 20.

In order to provide a higher rate of interrogation or improve interrogation coverage, more than one antenna unit may be placed at a single reader station.

This can be achieved, for example, by including a multiplexer unit enabling the scanning of more than one antenna by a single reader unit; or by inclusion of multiple reader units, each with their own antenna, within a single reader station.

The transponder 15 is electrically connected to the detection loop in such a manner that, should the detection loop be intact at the time the transponder can be interrogated, the transponder 15 can successfully transmit a response to the scanner unit 20. This response comprises a signal uniquely identifying the transponder. However, should the detection loop be broken, the transponder 15 is unable to transmit any response to the scanner unit 20, allowing the scanner unit 20 to detect when a fault has occurred in the belt 10 so as to break the detection loop.

It is to be noted that by providing a detection loop extending across the conveyor belt 10, the present invention allows all other components such as the transponder 15 to be situated at one side only of the belt. This allows the scanning components also to be situated on one side only of the belt, as depicted in FIG. 1c.

In the embodiment of the invention shown in FIG. 1a and 1c, the fault detection means 13 has been positioned so as to provide both tear detection and wear detection for the belt 10. That is, occurrence of a longitudinal tear in the belt 10 through the region occupied by fault detection means 13, will break the detection loop and enable detection of such a tear. Additionally, the detection loop is embedded at a depth in the belt corresponding to a wear limit of the belt, such that the occurrence of excessive wear of the belt in the region occupied by the fault detection means 13 will break the detection loop and allow such wear to be detected. Hence, such embodiments of the present invention provide a means of detecting wear to pre-set safe levels whilst the belt is in normal operation.

Once the groove in the conveyor belt 10 is filled, the fault detection means 13 is entirely embedded within the conveyor belt 10. In such embodiments of the invention, external wear caused by factors such as normal material loading and movement against rollers of the conveyor belt drive system, is unlikely to cause the fault detection means 13 to falsely indicate detection of a fault. Embedding the fault detection means entirely within the conveyor belt 10 will usually ensure that only a fault which is desired to be detected, such as a tear of the belt or excessive wear of the belt, will cause the detection loop to be broken and the transponder 15 to provide a negative indication when interrogated.

Furthermore, the fault detection means 13 is able to withstand repeated bending and elongation, such as is caused when the conveyor belt 10 passes around a final roller, or when edges of the belt 10 are raised so as to cradle material loaded onto the belt.

While not shown in FIG. 1, in particularly preferred embodiments of the invention, the fault detection means 13 further comprises a second electrically conductive detection loop positioned in the groove and extending across the conveyor belt 10, and a second transponder electrically connected to the second detection loop. By arranging the second transponder to operate in an inverse fashion to the transponder 15, such embodiments provide “fail-safe” fault detection. That is, the second transponder only provides a response to an interrogation when the second detection loop is broken. Such embodiments are particularly advantageous as they allow for failure of one or other of the transponders to be distinguished from the occurrence of a conveyor belt fault causing a break in the detection loops.

Preferably, a plurality of fault detection means in accordance with the present invention are placed at suitable positions along the conveyor belt 10.

The plurality of fault detection means may simply be spaced by a predetermined interval, and/or may be placed at positions of particular interest along the belt, such as at splicing positions or in new sections of belt. The fault detection means should be embedded in the conveyor belt at intervals that are considered suitable for the individual application.

In order to place each fault detection means across the conveyor belt, a groove must be formed in the belt 10. Preferably, such a groove is formed using an electrically heated cutting blade fixed to a hand-piece, for which power is supplied by a suitably rated transformer. The blade is made from a high tensile steel and formed into the desired shape, normally, but not necessarily restricted to, a truncated “V”, so as to form a groove of the cross-section shown in FIG. 1a. The blade retainer on the hand-piece is fabricated in such a way as to allow the height of the blade, and therefore the depth of the cut, to be adjusted.

Hence, the rip detection system of the present invention can be installed in a conveyor belt, with minimal intrusion into the belt structure and without the need for time consuming and expensive vulcanization processes. Furthermore, such a fault detection means can be retro-fitted to a wide range of different styled belt structures already in place.

In preferred embodiments of the invention the transponder is implemented by a TIRIS transponder produced by Texas Instruments, Texas, USA. Such transponders obtain power by charging a capacitor from an interrogation signal, and therefore connecting the detection loop in series or in parallel with the capacitor enables a breakage of the detection loop to be detected. It is to be appreciated that the present invention may be carried out by use of other types of transponder.

When a TIRIS transponder or the like is used, the provision of separate detection loops arranged with respective transponders so as to provide a “normally ON” mode of operation or a “normally OFF” mode of operation, enables “fail safe” fault detection to be provided, as discussed previously. In order to implement a normally OFF mode of operation or a normally ON mode of operation, a number of methods may be used. For example, connecting the detection loop to a non-intrusive passive shunt coil circuit and winding the shunt coil around the outside of the transponder's inductor will disable the transponder while the detection loop remains intact, thereby providing a fault detection means with a “normally OFF” mode of operation. When the detection loop is broken, the transponder will no longer be disabled, allowing detection that the normal mode of operation has ceased. A “normally OFF” mode of operation may also be provided by removing the transponder casing and winding a shunt coil directly around the inductor of the transponder. Again, the shunt coil is connected to the detection loop, such that while the detection loop remains intact, the transponder is disabled.

A “normally ON” mode of operation may be provided by connecting the detection loop in series with a charging circuit of the transponder. While the detection loop remains intact, the transponder is able to charge in the normal manner, from received interrogation signals, and able to respond in the normal manner. Breakage of the detection loop prevents the transponder from charging, and leads to the transponder being unable to respond.

A “normally OFF” mode of operation may be implemented by an intrusive insertion of the detection loop in parallel with a charging circuit of the transponder. While the detection loop is intact, no voltage and no charge may be developed by the charging circuit of the transponder, preventing the transponder from responding to an interrogation. Breakage of the detection loop permits the transponder charging circuit to develop charge and voltage in the normal manner, and therefore allows the transponder to respond to interrogation.

Preferably, in each groove or insertion of the type shown in FIG. 1a, two independent fault detection means are placed, each comprising a transponder and a detection loop. One of the fault detection means adopts a “normally OFF” mode of operation, and is provided with a unique tear identification. The other fault detection means adopts a “normally ON” mode of operation and is provided with a unique indexing identification. The loops are electrically isolated from each other but are bonded in close proximity, within perhaps millimeters of each other. In the event of both loops being broken such as is caused by a belt tear, both the indexing probe will cease to transmit and the tear detection identifier will commence transmissions. Such an event confirms with a high probability the presence of a belt tear rather than the failure of a transponder unit.

It is to be appreciated that other methods of providing “failsafe” rip detection may be provided.

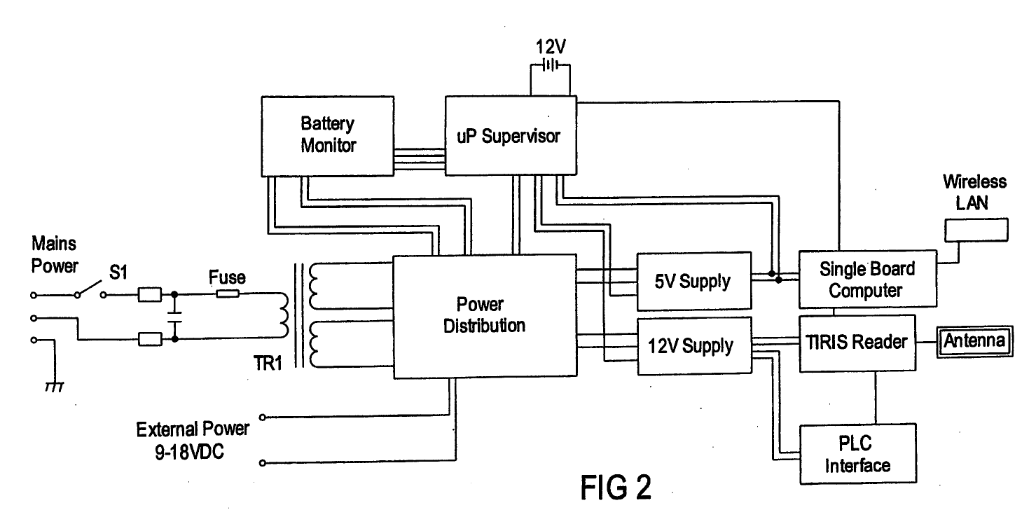

FIG. 2 is a block diagram of one embodiment of the scanner unit 20, subsequently referred to herein as a reader unit. The reader unit 20 comprises a power supply and a uninterrupted power supply (UPS) linked via a microsupervisor to a single-board computer system for the purpose of black-out and grey-out power management. The micro-supervisor also provides battery, environmental and cabinet intrusion monitoring data to the single-board computer. The single-board computer also controls, logs and processes the TIRIS data and communicates both Reader Unit data and configuration information to and from the Monitoring Station. The single-board computer also controls the alternative direct PLC interface.

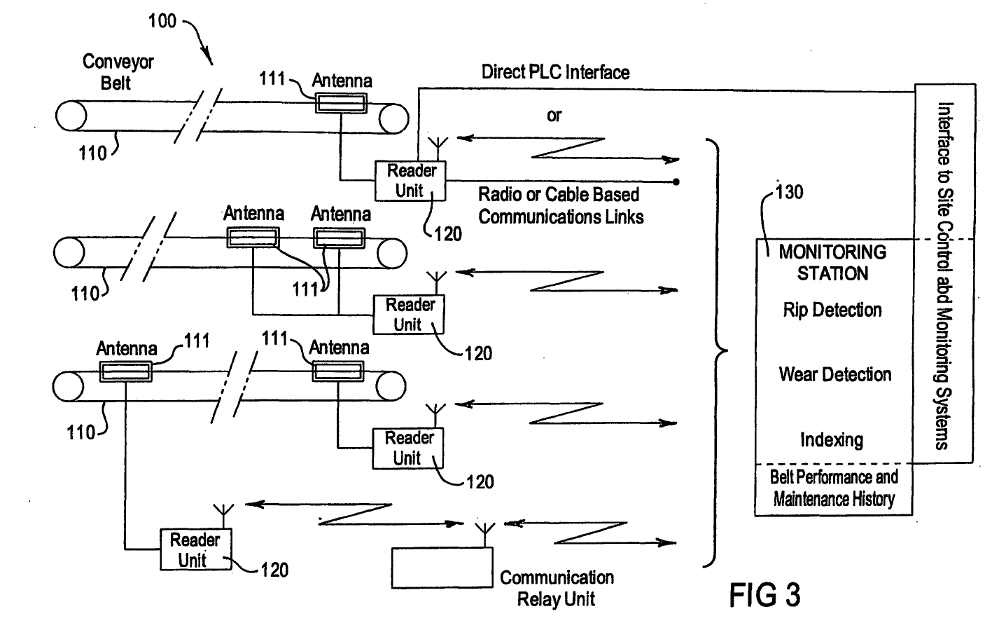

FIG. 3 illustrates a system 100 for monitoring a plurality of conveyor belts 110 in accordance with the preset invention. Each conveyor belt has a plurality of identifiers or antennae 111 embedded at spaced apart positions in the belts 110, each identifier 111 comprising a TIRIS transponder operable to receive a wireless interrogation and to provide a wireless response uniquely identifying that identifier. Each transponder, is encased in a sturdy enclosure, for example a GRP fiberglass tube.

Associated with each belt is at least one reader unit 120, each of which may contain one or more independent belt insert interrogation units. A belt 110 or system of belts may have one or more reader units 120. Each reader unit 120 is uniquely identified and communicates, via radio or cable link, status data of the belt 110 and reader unit 120 to a monitoring station 130. The monitoring station 130 provides displays which present alarms, warnings and system status information. The display system is hierarchical with a drill down capacity providing successively more specific detail of system components. The higher level provides site-wide information while lower levels provide details of individual belts and/or reader units. The monitoring station 130 also provides a belt map utilizing the unique insert identifiers or indexing capability. That is, due to the ability to uniquely identify each insert or identifier 111, a map of relative locations of all inserts within a belt 110, combined with belt history data, can be compiled. Coupled with a maintenance database this provides belt history information for maintenance management. The monitoring station 130 also provides a site-specific interface to control systems for the purpose of alarm response. Alternatively a direct PLC switch interface is available. The operating computer software will keep track of each transponder 111 in the conveyor belt 110 and is able to calculate the geographic position of any desired transponder.

The system is a self-learning system such that as new inserts are placed into a belt their relative location is automatically learned. This enables repair teams, for example, to be sent directly to a specific point on the belt, or enables the belt to be halted when the specific point on the belt is at a desired location.

Further, the system monitors the current status of individual devices inserted in a belt whether for the purposes of indexing; tear detection and/or wear indication. Such a status may include whether the device is operational and an indication of a warning, or a failure due to a tear or wear. The system may further monitor current belt speed and recent speed history, and maintain a dynamic belt map, that is a belt map evolving with time, indicating current location of belt segments and identifiers. The monitoring station 130 may provide electronic data feeds to other plant monitoring systems, and maintains a belt history data base.

Such a system enables monitoring of the occurrence of faults, as well as simply monitoring certain points of the belt 110 at which an identifier is located.

Each unique identifier may be placed in a lateral edge of the belt by forming a hole in a laterally disposed surface of the conveyor belt; placing the identifier in the hole; and

sealing the hole. A system has been devised for easy insertion of the indexing inserts. This comprises an adjustable drilling jig, and an insertion tool. The drilling jig allows a suitable diameter hole to be drilled into the belt edge at a desired distance below the surface of the top cover and above the steel or fabric reinforcement of the conveyor belt. The hole diameter is selectable to accommodate different diameters of identifiers. The insertion tool has a thin wall barrel and an open breach at the handle end. The barrel is pushed into the hole drilled into the belt edge and the identifier placed into the breech of the tool. A push rod is used to push the identifier into the belt. A rubber plug is then placed in the breech and pushed into the hole, effectively sealing the hole and identifier from dirt and moisture ingress. Glue may also be used to seal the plug in the hole. Such a system allows the identifiers to be retrofitted to a wide range of different styled belt structures.

Further, a degree of protection for the identifier is preferable to provide durability. Preferably the electronic identifiers are protected from damage by encapsulating them within a specially produced fiberglass tube. Identifiers can also be protected by encapsulating them in a polycarbonate tube, or encapsulating the identifier in epoxy or polyester resin.

The passive transponders are embedded close to the edge of the conveyor belt at intervals considered suitable for the length of belt to be indexed. Points of interest such as belt splices or new sections of belt can be specifically identified by the transponders. Accordingly, such embodiments of the present invention provide a means of electrically indexing the belt to provide identification of splices, replaced sections of belt and other points of interest, whilst the belt is in motion at normal service speeds, and further can accurately geographically locate any desired portion of the conveyor belt, whilst the belt is in normal operation. This provides a reliable means for collecting belt history data useful for comparison with manufacturer guarantees, and the planning and costing of maintenance. The indexing provides a mechanism for a, dynamic belt map. When a belt is stopped the system can then provide accurate guidance to the location of any specific section of belt. This allows construction of an operating history database, allowing planned maintenance based on history and wear detection, and minimizing inventory requirements.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-36. (canceled)

37. A conveyor belt monitoring system indicating a level of wear or tear of a conveyor belt, comprising:
a first detection member residing within the conveyor belt at a predetermined depth below a load carrying surface of the belt, the first detection member electrically conductive when intact and electrically non-conductive when breached, and arranged such that the first detection member is breached when the level of wear or tear of the belt reaches or exceeds said predetermined depth; and
a first transmitter electrically connected to the first detection member, the first transmitter, in use, only transmitting a signal when the first detection member is electrically non-conductive.

38. The conveyor belt monitoring system according to claim 37, further comprising:
a second detection member residing within the conveyor belt in close proximity to the first detection member at substantially the same predetermined depth below the load carrying surface of the belt, the second detection member electrically conductive when intact and electrically non-conductive when breached, and arranged such that the second detection member is breached when the level of wear of tear of the belt reaches or exceeds said predetermined depth; and
a second transmitter electrically connected to the second detection member, the second transmitter, in use, only transmitting a signal when the second detection member is electrically conductive.

39. The conveyor belt monitoring system according to claim 37 wherein the first and/or second detection member includes one or more conductors configured as a conductive loop.

40. The conveyor belt monitoring system according to claim 39 wherein the conductors are pleated or corrugated along their length such that portions of the conductors are disposed above a nominal plane extending through the conductive loop, said portions, in use, being subject to wear and consequent breach prior to any conductors residing within said nominal plane.

41. The conveyor belt monitoring system according to claim 37 wherein the first and/or second detection member extends substantially across the conveyor belt.

42. The conveyor belt monitoring system according to claim 37 wherein the first transmitter includes a radio frequency transponder.

43. The conveyor belt monitoring system according to claim 42 further including a scanner unit that generates a radio frequency interrogation signal, and wherein the transponder of the first transmitter is non-responsive to the interrogation signal when the first detection member is electrically conductive, and responsive to the interrogation signal when the first detection member is electrically non-conductive.

44. The conveyor belt monitoring system according to claim 38, wherein the first and second transmitters include a radio frequency transponder, wherein the conveyor belt monitoring system further includes a scanner unit that generates a radio frequency interrogation signal, and wherein the transponder of the first transmitter is non-responsive to the interrogation signal when the first detection member is electrically conductive, and responsive to the interrogation signal when the first detection member is electrically non-conductive, and wherein the transponder of the second transmitter is responsive to the interrogation signal generated by the scanner unit when the second detection member is electrically conductive, and non-responsive to the interrogation signal when the second detection member is electrically non-conductive.

45. The conveyor belt monitoring system according to claim 44 including a plurality of first and second detection members each electrically connected to respective transmitters, each transmitter including a radio frequency transponder operable to respond to said interrogation signal of said scanner unit with a signal including information that uniquely identifies the transponder.

46. The conveyor belt monitoring system according to claim 45 further including one or more additional indexing transponders affixed to the conveyor belt, each indexing transponder operable to respond to said interrogation signal of said scanner unit with a signal including information that uniquely identifies the transponder.

47. The conveyor belt monitoring system according to claim 43 wherein the scanner unit is operably connected to an antenna positioned adjacent the conveyor belt and a reader unit that receives the signal received by the antenna, the reader unit also including a processor for processing the signal and logging the processed signal as data.

48. The conveyor belt monitoring system according to claim 47 including a monitoring station in communication with the reader unit by cable or radio frequency transmission, wherein the monitoring station presents the data as system status information relating to the level of wear of the conveyor belt.

49. The conveyor belt monitoring system according to claim 48, wherein the monitoring station provides a geographical location of the first detection member.

50. The conveyor belt monitoring system according to claim 48, wherein the monitoring station produces a visible and/or audible signal when the first second detection member is breached.

51. The conveyor belt monitoring system according to claim 48, wherein the monitoring station controls operation of the conveyor belt, and the monitoring station stops operation of the conveyor belt when the first detection member is breached.

52. The conveyor belt monitoring system according to claim 47, wherein the operation of the conveyor belt is controlled by a PLC system in communication with the reader unit.

53. The conveyor belt monitoring system according to claim 52, wherein the PLC system stops operation of the conveyor belt when the first detection member is breached.

54. A conveyor belt monitoring system for indicating a level of wear or tear of a conveyor belt, comprising:
a scanner unit that generates a radio frequency interrogation signal, the scanner unit operably connected to an antenna positioned adjacent the conveyor belt and a reader unit that receives the signal received by the antenna, the reader unit also including a processor for processing the signal and logging the processed signal as data;
at least one pair of detection members residing within the conveyor belt, the first and second detection members of the at least one pair being located in close proximity to one another at a predetermined depth below a load carrying surface of the belt, said first and second detection members being electrically conductive when intact and electrically non-conductive when breached, and arranged such that the detection members are breached when the level of wear or tear of the belt reaches or exceeds said predetermined depth;
said first and second transmitters electrically connected to said first and second detection members respectively, each transmitter including a radio frequency transponder, wherein the transponder of the first transmitter is non-responsive to the interrogation signal when the first detection member is electrically conductive, and responsive to the interrogation signal when the first detection member is electrically non-conductive and the transponder of the second transmitter is responsive to the interrogation signal when the second detection member is electrically conductive, and non-responsive to the interrogation signal when the first detection member is electrically non-conductive; and
a monitoring station in communication with the reader unit by cable or radio frequency transmission, the monitoring station including a PLC system controlling the operation of the conveyor belt;
wherein the PLC system stops operation of the conveyor belt when the first and/or second detection member is breached.

55. A conveyor belt wear indicator for use with a conveyor belt monitoring system to indicate a level of wear or tear of the conveyor belt, the wear indicator comprising:
a first detection member for embedment within the conveyor belt at a predetermined depth below a load carrying surface of the belt, the first detection member being electrically conductive when intact and electrically non-conductive when breached; and
a first transmitter electrically connected to the first detection member, the first transmitter, in use, only transmitting a signal when the first detection member is electrically non-conductive.

56. The wear indicator according to claim 55, further including:
a second detection member for embedment within the conveyor belt in close proximity to the first detection member at substantially the same predetermined depth below the load carrying surface of the belt, the second detection member being electrically conductive when intact and electrically non-conductive when breached; and
a second transmitter electrically connected to the second detection member, the second transmitter, in use, only transmitting a signal when the second detection member is electrically conductive.

57. The wear indicator according to claim 55 wherein the first and/or second detection member includes one or more conductors configured as a conductive loop.

58. The wear indicator according to claim 57 wherein the conductors are pleated or corrugated along their length such that portions of the conductors are disposed above a nominal plane extending through the conductive loop, said portions, in use, being subject to wear and consequent breach prior to any conductors residing within said nominal plane.

59. The wear indicator according to claim 55, the first transmitter including a radio frequency transponder configured to receive a radio frequency interrogation signal generated by a scanner unit, wherein the transponder is non-responsive to the interrogation signal when the first detection member is electrically conductive, and responsive to the interrogation signal when the first detection member is electrically non-conductive.

60. The wear indicator according to claim 56, the first and second transmitters each including a radio frequency transponder configured to receive a radio frequency interrogation signal generated by a scanner unit, wherein the transponder of the first transmitter is non-responsive to the interrogation signal when the first detection member is electrically conductive, and responsive to the interrogation signal when the first detection member is electrically non-conductive, and the transponder of the second transmitter is responsive to the interrogation signal generated by the scanner unit when the second detection member is electrically conductive, and non-responsive to the interrogation signal when the second detection member is electrically non-conductive.

61. The wear indicator according to claim 59 wherein the first radio frequency transponder is operable to respond to said interrogation signal of said scanner unit with a signal including information that uniquely identifies the transponder.

62. A conveyor belt having a major longitudinal axis, a structural component and a load bearing component overlaying the structural component, the conveyor belt further comprising:
a first detection member residing within the conveyor belt at a predetermined depth below the surface of the load bearing component, the first detection member being electrically conductive when intact and electrically non-conductive when breached; and
a first transmitter electrically connected to the first detection member, the first transmitter, in use, only transmitting a signal when the first detection member is electrically non-conductive;
wherein, the first detection member is oriented transverse to the major longitudinal axis of the belt and extends substantially across the conveyor belt.

63. The conveyor belt according to claim 62, further including:
a second detection member residing within the conveyor belt in close proximity to the first detection member with substantially the same orientation and at substantially the same predetermined depth below the load carrying surface of the belt, the second detection member being electrically conductive when intact and electrically non-conductive when breached; and
a second transmitter electrically connected to the second detection member, the second transmitter, in use, only transmitting a signal when the second detection member is electrically conductive.

64. The conveyor belt according to claim 62, wherein the first detection member is oriented substantially perpendicular to the major axis of the conveyor belt.

65. The conveyor belt according to claim 62, wherein the first detection member is oriented at an acute angle to the major axis of the conveyor belt.

66. The conveyor belt according to claim 62, wherein the depth at which the first detection member resides below the surface of the load bearing component represents a level of wear of the belt for which an indication is required.

67. The conveyor belt according to claim 66, wherein the belt includes a plurality of detection members residing at different depths below the surface of the load bearing component of the belt.

68. The conveyor belt according to claim 67, wherein the plurality of detection members are oriented at different angles relative to the major longitudinal axis of the conveyor belt.

69. The conveyor belt according to claim 62, wherein the first transmitter is positioned adjacent one side edge of the conveyor belt.

70. The conveyor belt according to claim 62, wherein the detection member and transmitter are entirely embedded within the load bearing component of the conveyor belt.

71. The conveyor belt according to claim 62, wherein the detection member is associated with the structural component of the conveyor belt.

72. The conveyor belt according to claim 71, wherein the detection member is formed integrally with the structural component.

73. A method of installing a conveyor belt wear indicator by embedding the indicator in a conveyor belt, comprising the steps of:
forming a groove in a surface of the conveyor belt substantially across the conveyor belt; and
placing a first wear indicator, including a first detection member electrically connected to a first transmitter, in the groove such that the detection member extends substantially across the conveyor belt.

74. The method according to claim 73 wherein the first detection member is electrically conductive when intact and electrically non-conductive when breached, and the first transmitter, in use, only transmits a signal when the first detection member is electrically non-conductive.

75. The method according to claim 74 further including the step of placing a second wear indicator in the groove, wherein the second wear indicator includes:
a second detection member that is electrically conductive when intact and electrically non-conductive when breached; and
a second transmitter electrically connected to the second detection member, the second transmitter, in use, only transmits a signal when the second detection member is electrically conductive.

76. The method according to claim 73, wherein the groove is formed in a load carrying surface of the conveyor belt, and the method further includes the step, after placing the wear indicator(s) in the groove, of filling the groove with a material.

77. The method according to claim 76 wherein said material has a surface wear rate substantially identical to a wear rate of the load carrying surface of the conveyor belt.

78. A method of installing a conveyor belt indexing transponder into a conveyor belt comprising the steps of:
forming a hole in an edge of the conveyor belt;
locating within said hole an indexing transponder operable to respond to an interrogation signal generated by a scanner unit, said response including information that uniquely identifies the transponder; and
sealing the hole.

79. The method according to claim 78 wherein the step of forming a hole includes drilling a hole in the side edge of the belt of diameter suitable to receive the indexing transponder, and the step of locating the indexing transponder within the hole includes the steps of:
providing an insertion tool having a barrel with an opening at the handle end;
inserting the barrel of the insertion tool into the hole;
placing the indexing transponder into the opening of the insertion tool; and
using a push rod to push the indexing transponder into the hole.

80. The method according to claim 79 wherein the step of sealing the hole includes placing a rubber plug into the opening of the insertion tool and subsequently operating the push rod to force the rubber plug into the hole.

81. The method according to claim 80 wherein the step of sealing the hole further includes applying an adhesive to the rubber plug.

82. The method according to claim 78 wherein the indexing transponder is encased in a protective enclosure.

83. The method according to claim 82 wherein the protective enclosure includes one or more of a fiberglass tube, a polycarbonate tube, or an epoxy or polyester resin encapsulation.

84. An indexing transponder for installation into a conveyor belt, the indexing transponder operable to respond to an interrogation signal generated by a scanner unit, said response including information that uniquely identifies the transponder, said radio frequency transponder being encased in a protective closure for placement in an insertion tool having a barrel and an opening at the handle end of the tool, whereafter the indexing transponder and protective closure are inserted into a hole formed in the conveyor belt using a push rod of the tool to force the indexing transponder into the hole through the barrel of the tool.

85. The indexing transponder according to claim 84 wherein the protective enclosure includes one or more of a fiberglass tube, a polycarbonate tube, or an epoxy or polyester resin encapsulation.
